(19) United States
(12) Patent Application Publication
(10) Pub. No.: US 2005/0252031 A1
(43) Pub. Date: Nov. 17, 2005

(54) Clothes dryer

(75) Inventors: Dae-Yun Park, Gwangmyeong (KR); Young-Hwan Park, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/017,808

(22) Filed: Dec. 22, 2004

(30) Foreign Application Priority Data
May 13, 2004 (KR) 33960/2004

(51) Int. Cl. F26B 11/02

(52) U.S. Cl. 34/601; 34/608

(57) ABSTRACT

The present invention discloses a clothes dryer including a drum rotatably installed in a cabinet, a plurality of vent holes being formed on the circumferential surface of the drum, first and second ducts coupled to the drum, respectively, for sucking and exhausting air to/from the drum, and a fan motor for forcibly sending air through the first and second ducts. Here, at least one of the first and second ducts is linked to the plurality of vent holes. The clothes dryer can increase a capacity of the drum without increasing a size of the cabinet.

### BACKGROUND OF THE INVENTION

1. Field of the Invention

The present invention relates to a clothes dryer, and more particularly to, a clothes dryer which can increase a capacity of a drum without increasing a size of a cabinet.

2. Description of the Background Art

FIG. 1 is a cross-sectional diagram illustrating a conventional clothes dryer. Referring to FIG. 1, the conventional clothes dryer includes a cabinet 111 having an inside space, a drum 121 rotatably disposed in the cabinet 111, a suction duct 131 formed at one side of the drum 121, for supplying sucked air to the drum 121, a suction fan 135 rotatably disposed in the suction duct 131, a heater 141 disposed in the suction duct 131, for heating air, and a driving motor 137 disposed at one side of the drum 121, for driving the drum 121 and the suction fan 135.

A door 113 is formed on the front surface of the cabinet 111, so that the user can put clothes in the cabinet 111 or take out the clothes, and an inlet unit 115 is formed on the rear surface of the cabinet 111 to supply air into the cabinet 111.

An exhaust hole 123 and an exhaust duct 125 are formed at one side of the front surface of the drum 121 to exhaust inside air. A suction duct 131 is disposed at one side of the rear surface of the drum 121 in the vertical direction to supply the inside air of the cabinet 111 into the drum 121.

A suction hole 132 is formed at the bottom region of the suction duct 131, and the cylindrical suction fan 135 is formed inside the suction hole 132. The driving motor 137 is installed outside the suction hole 132 to rotatably drive the drum 121 and the suction fan 135.

On the other hand, the heater 141 is installed at the top inside region of the suction duct 131 to heat upward air sucked through the suction hole 132.

The heater 141 includes a casing 142 having an inside passage for air flow, coils 143 disposed inside the casing 142 in a zigzag shape in the orthogonal direction to the air flow direction, for heating air, and a plurality of supporting means 145 disposed in the air flow direction separately from each other in the width direction of the casing 142, for supporting the coils 143.

However, the conventional clothes dryer has the following disadvantages.

In order to dry many clothes, the drum must be enlarged to have a large capacity. For this, a method for increasing a diameter of a drum has been suggested. However, in the conventional clothes dryer, the diameter of the drum is already approximate to the width of the cabinet. Therefore, the cabinet must be enlarged in advance to increase the diameter of the drum. The outline size of the cabinet has been standardized in some countries. It is thus limitative to increase the diameter of the drum.

A method for increasing a length of a drum has also been suggested. In the conventional clothes dryer, the suction duct and the exhaust duct are installed on the front and rear surfaces of the drum. Accordingly, a length L2 of the drum is smaller than a length L1 of the cabinet by the spaces of the suction and exhaust ducts. It is also limitative to increase the length L2 of the drum due to positions and arrangements of the suction duct and the exhaust duct.

As described above, it is not easy to increase the capacity of the drum in the conventional clothes dryer.

In addition, the suction duct is protruded from the rear surface of the cabinet, and thus the whole length of the clothes dryer is larger than the length L1 of the cabinet. The suction duct exposed on the cabinet is easily damaged, and does not look good externally.

### SUMMARY OF THE INVENTION

Therefore, an object of the present invention is to provide a clothes dryer which can increase a capacity of a drum without increasing a size of a cabinet.

To achieve these and other advantages and in accordance with the purpose of the present invention, as embodied and broadly described herein, there is provided a clothes dryer, including: a drum rotatably installed in a cabinet, a plurality of vent holes being formed on the circumferential surface of the drum; first and second ducts coupled to the drum, respectively, for sucking and exhausting air to/from the drum; and a fan motor for forcibly sending air through the first and second ducts, wherein at least one of the first and second ducts is linked to the plurality of vent holes.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional diagram illustrating a conventional clothes dryer;

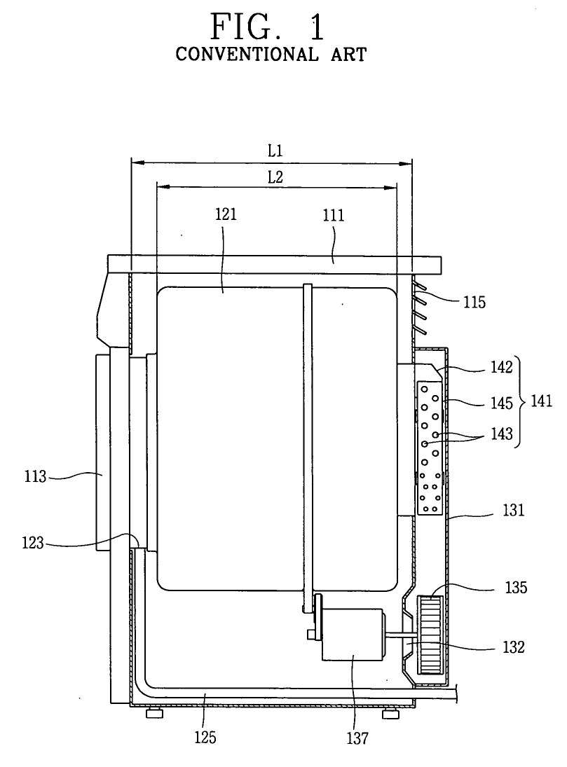

FIG. 2 is a cross-sectional diagram illustrating a clothes dryer in accordance with a first embodiment of the present invention;

FIG. 3 is a cross-sectional diagram taken along line III-III of FIG. 2;

FIG. 4 is an enlarged diagram illustrating IV of FIG. 2;

FIG. 5 is a cross-sectional diagram illustrating a clothes dryer in accordance with a second embodiment of the present invention;

FIG. 6 is a cross-sectional diagram taken along line VI-VI of FIG. 5;

FIG. 7 is a cross-sectional diagram illustrating a cap member, taken along line VII-VII of FIG. 6;

FIG. 8 is a cross-sectional diagram illustrating a clothes dryer in accordance with a third embodiment of the present invention; and

FIG. 9 is a cross-sectional diagram illustrating a clothes dryer in accordance with a fourth embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

A clothes dryer in accordance with the most preferred embodiments of the present invention will now be described in detail with reference to the accompanying drawings.

In addition, the scope of the present invention is not limited to the specific embodiments described below, but modified as recited in the appended claims.

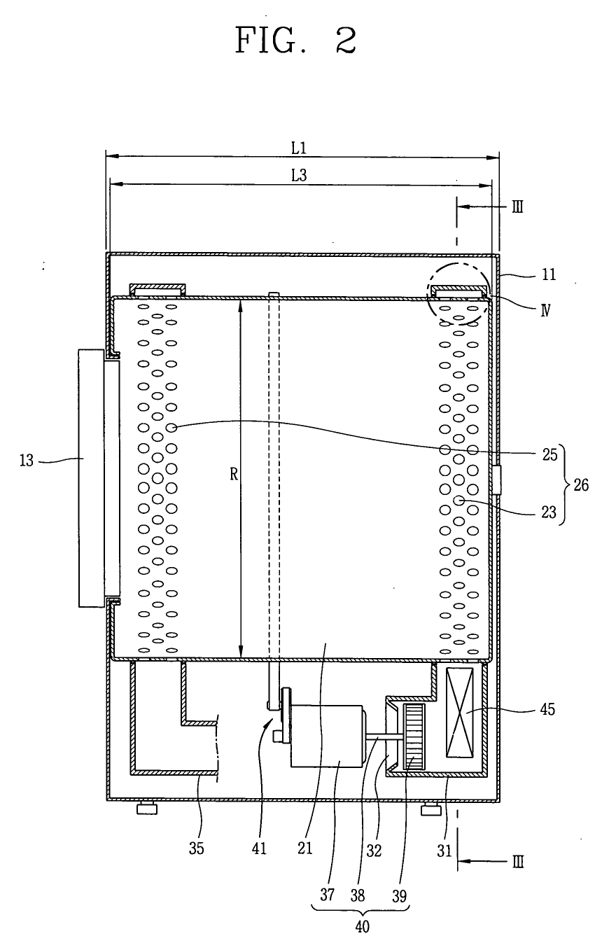

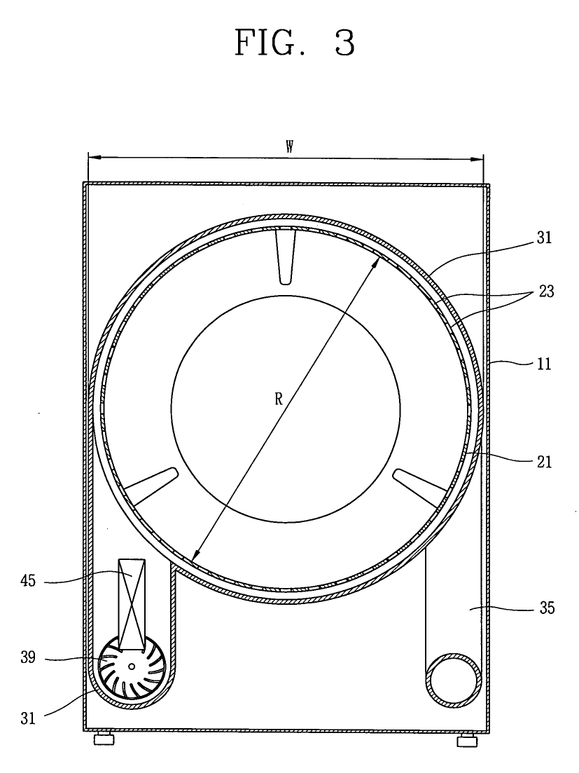

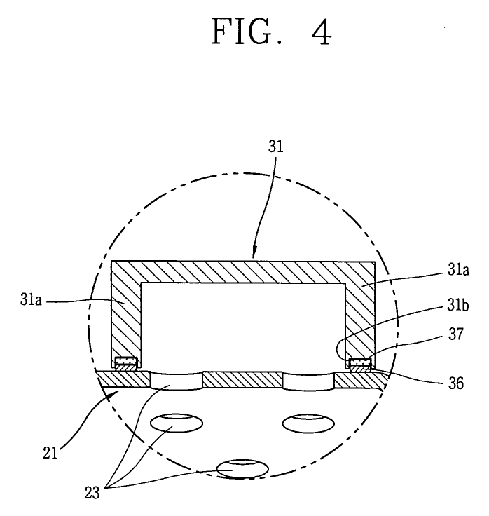

FIG. 2 is a cross-sectional diagram illustrating a clothes dryer in accordance with a first embodiment of the present invention, FIG. 3 is a cross-sectional diagram taken along line III-III of FIG. 2, and FIG. 4 is an enlarged diagram illustrating IV of FIG. 2.

As illustrated in FIG. 2, in accordance with the first embodiment of the present invention, the clothes dryer includes a drum 21 rotatably installed in a cabinet 11, a plurality of vent holes 26 being formed on the circumferential surface of the drum 21, first and second ducts 31 and 35 coupled to the drum 21, respectively, for sucking and exhausting air to/from the drum 21, and a fan motor 40 for forcibly sending air through the first and second ducts 31 and 35. Here, at least one of the first and second ducts 31 and 35 is linked to the plurality of vent holes 26.

The structure of the clothes dryer in accordance with the first embodiment of the present invention will now be explained in more detail.

The cabinet 11 is formed in a rectangular-parallelepiped shape. An opening is formed on the front surface of the cabinet 11 so that the user can put clothes in the cabinet 11 or take out the clothes. The opening is opened/closed by a door 13 installed outside the cabinet 11.

The drum 21 is formed in a cylindrical shape having its front surface opened. The drum 21 is rotatably installed on the cabinet 11 so that its opened front surface can match with the opening of the cabinet 11. A length L3 of the drum 21 is almost identical to a length L1 of the cabinet 11.

The plurality of vent holes 26 include a first plurality of vent holes 23 arranged at one side of the circumferential surface of the drum 21 in the rotary direction, and a second plurality of vent holes 25 arranged at the other side of the circumferential surface of the drum 21 in the rotary direction, separately from the first plurality of vent holes 23.

The first and second pluralities of vent holes 23 and 25 can be arranged at any parts of the circumferential surface of the drum 21 in the rotary direction. Preferably, the first and second pluralities of vent holes 23 and 25 are arranged at both ends of the circumferential surface of the drum 21 in the rotary direction, respectively. In addition, preferably, the first and second pluralities of vent holes 23 and 25 are arranged on the circumferential surface of the drum 21 vertically to a rotary axis of the drum 21.

Both the first duct 31 and the second duct 35 are disposed on the circumferential surface of the drum 21 to be linked to the plurality of vent holes 26.

That is, the first duct 31 is disposed on the circumferential surface of the drum 21 to cover the first plurality of vent holes 23, and the second duct 35 is disposed on the circumferential surface of the drum 21 to cover the second plurality of vent holes 25.

The first duct 31 and the second duct 35 are formed in a hoop shape to cover the first and second pluralities of vent holes 23 and 25, respectively.

As shown in FIG. 4, the first duct 31 and the second duct 35 are formed in a channel-sectional shape so that air passages can be formed between the first and second ducts 31 and 35 and the circumferential surface of the drum 21. Gaskets 36 are mounted between the sidewalls 31a of the first and second ducts 31 and 35 and the circumferential surface of the drum 21 in order to prevent air flowing through the first and second ducts 31 and 35 from being externally leaked. That is, housing grooves 31b are caved in the thickness direction of the ends of the sidewalls (the covering portions) 31a of the first and second ducts 31 and 35 and extended in the circumferential direction, and the gaskets 36 are mounted on the housing grooves 31b closely to the circumferential surface of the drum 21. In addition, elastic members 37 such as sponges are installed in the housing grooves 31b behind the gaskets 36 to apply an elastic force to the gaskets 36 to elastically contact the circumferential surface of the drum 21.

The fan motor 40 is installed at an inlet side 32 of the first duct 31 to supply air into the drum 21 through the first duct 31.

That is, the fan motor 40 includes a driving motor 37 installed outside the inlet side 32 of the first duct 31 at one side of the circumferential surface of the drum 21, a rotary axis 38 extended from both ends of the driving motor 37, and a suction fan 39 coupled to one end of the rotary axis 38, and disposed inside the inlet side 32 of the first duct 31.

The suction fan 39 is rotated with the rotary axis 38 by the driving operation of the driving motor 37, for forcibly sending inside air of the cabinet 11 into the drum 21 through the first duct 31.

A double pulley system 41 is installed on the rotary axis 38 extended to the rear side of the driving motor 37 to cause rotation of the drum 21.

A heater 45 is disposed inside the inlet side 32 of the first duct 31 at one side of the suction fan 39 to heat air sucked to the first duct 31. That is, the suction fan 39 and the heater 45 are disposed at one side of the circumferential surface of the drum 21, not both sides of the drum 21. Accordingly, the length L2 of the drum 21 can be almost identical to the length L1 of the cabinet 11.

Here, the second duct 35 provides an exhaust passage for exhausting the air sucked into the drum 21 through the first duct 31 from the cabinet 11.

Conversely, the second duct 35 can compose the air suction passage, and the first duct 31 can compose the exhaust passage for exhausting inside air of the drum 21 from the cabinet 11.

The operation of the clothes dryer in accordance with the first embodiment of the present invention will now be explained.

When power is applied to the driving motor 37, the rotary axis 38 of the driving motor 37 is rotated. Here, the suction fan 39 and the drum 21 are rotated, respectively. As the suction fan 39 is rotated, air is sucked into the first duct 31. The sucked air is heated by the heater 39, flows in the circumferential direction of the drum 21 through the first duct 31, and is supplied into the drum 21 through the first plurality of vent holes 23. The air contacting the clothes and taking moisture in the drum 21 is exhausted from the drum 21 through the second plurality of vent holes 25, and then exhausted from the cabinet 11 through the second duct 35.

A clothes dryer in accordance with a second embodiment of the present invention will now be described in detail.

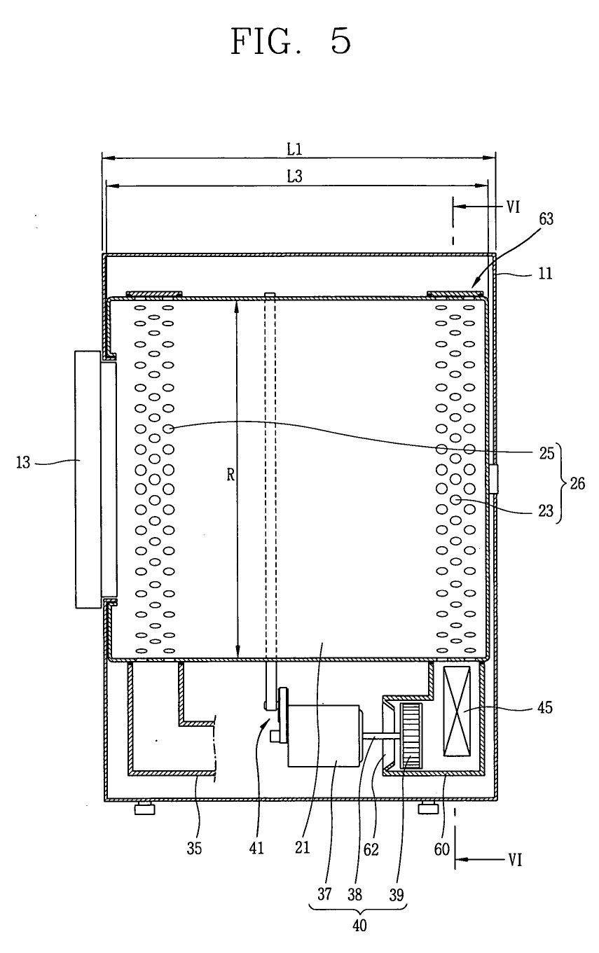

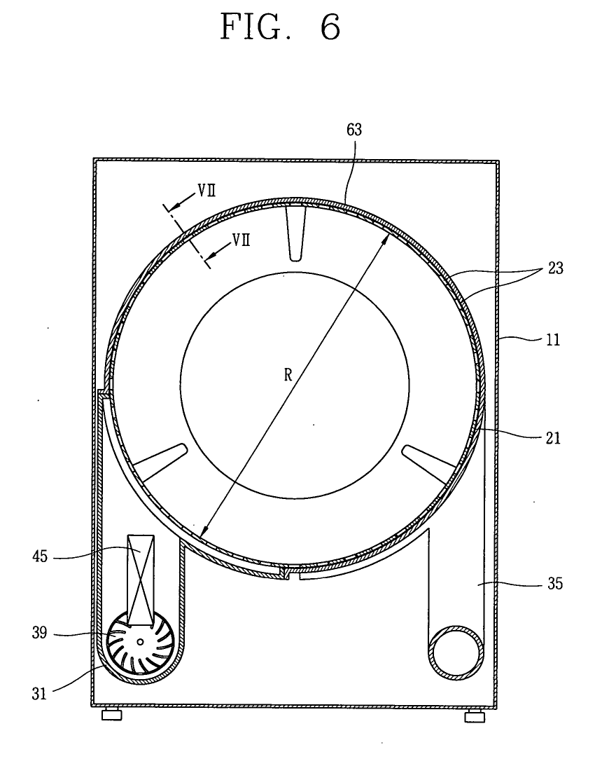

FIG. 5 is a cross-sectional diagram illustrating the clothes dryer in accordance with the second embodiment of the present invention, and FIG. 6 is a cross-sectional diagram taken along line VI-VI of FIG. 5. Same drawing reference numerals are used for the same elements as those of the first embodiment of the present invention.

Referring to FIG. 5, in accordance with the second embodiment of the present invention, the clothes dryer includes a drum 21 rotatably installed in a cabinet 11, a plurality of vent holes 26 being formed on the circumferential surface of the drum 21, first and second ducts 60 and 61 coupled to the drum 21, respectively, for sucking and exhausting air to/from the drum 21, and a fan motor 40 for forcibly sending air through the first and second ducts 60 and 61. Here, at least one of the first and second ducts 60 and 61 is linked to the plurality of vent holes 26.

The structure of the clothes dryer in accordance with the second embodiment of the present invention will now be explained in more detail.

The cabinet 11 is formed in a rectangular-parallelepiped shape. An opening is formed on the front surface of the cabinet 11 so that the user can put clothes in the cabinet 11 or take out the clothes. The opening is opened/closed by a door 13 installed outside the cabinet 11.

The drum 21 is formed in a cylindrical shape having its front surface opened. The drum 21 is rotatably installed on the cabinet 11 so that its opened front surface can match with the opening of the cabinet 11. A length L3 of the drum 21 is almost identical to a length L1 of the cabinet 11.

The plurality of vent holes 26 include a first plurality of vent holes 23 arranged at one side of the circumferential surface of the drum 21 in the rotary direction, and a second plurality of vent holes 25 arranged at the other side of the circumferential surface of the drum 21 in the rotary direction, separately from the first plurality of vent holes 23.

The first and second pluralities of vent holes 23 and 25 can be arranged at any parts of the circumferential surface of the drum 21 in the rotary direction. Preferably, the first and second pluralities of vent holes 23 and 25 are arranged at both ends of the circumferential surface of the drum 21 in the rotary direction, vertically to a rotary axis of the drum 21.

Both the first duct 60 and the second duct 61 are disposed on the circumferential surface of the drum 21 to be linked to the plurality of vent holes 26.

That is, the first duct 60 is disposed on the circumferential surface of the drum 21 to cover part of the first plurality of vent holes 23, and the second duct 61 is disposed on the circumferential surface of the drum 21 to cover part of the second plurality of vent holes 25.

Preferably, the first duct 60 and the second duct 61 are formed at the lower portion of the drum 21 in a channel-sectional shape, so that air passages can be formed between the first and second ducts 60 and 61 and the circumferential surface of the drum 21.

Although not illustrated, as identical to the first embodiment (refer to FIG. 4) of the present invention, housing grooves are caved in the thickness direction of the ends of the sidewalls (the covering portions) of the first and second ducts 60 and 61 contacting the circumferential surface of the drum 21, and extended in the circumferential direction, and gaskets are installed on the housing grooves closely to the circumferential surface of the drum 21 to prevent air from being externally leaked. Elastic members for applying an elastic force to the gaskets are installed in the housing grooves behind the gaskets.

On the other hand, a cap member 63 is installed on the circumferential surface of the drum 21 to block the first plurality of vent holes 23 which are not covered with the first duct 60, and a cap member 63 is installed on the circumferential surface of the drum 21 to block the second plurality of vent holes 25 which are not covered with the second duct 61.

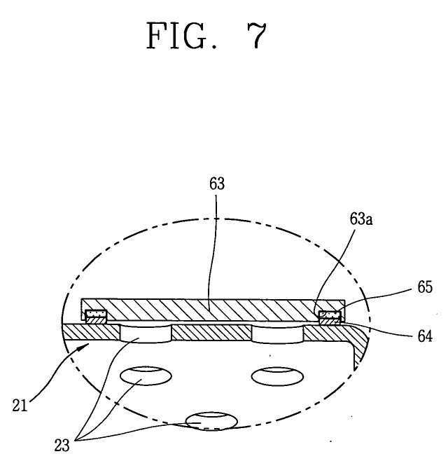

As shown in FIG. 7, the cap members 63 are formed in a hoop shape having a curvature corresponding to an outside diameter of the drum 21. Housing grooves 63a caved in the thickness direction and extended in the circumferential direction are formed on the inside surface of the cap members 63. Gaskets 64 are installed on the housing grooves 63a closely to the circumferential surface of the drum 21 in order to prevent inside air of the drum 21 from being externally leaked through the first and second vent holes 23 and 25. In addition, elastic members 65 such as sponges are installed in the housing grooves 63a behind the gaskets 64 to apply an elastic force to the gaskets 64.

The fan motor 40 is installed at an inlet side 62 of the first duct 60 to supply air into the drum 21 through the first duct 60.

That is, the fan motor 40 includes a driving motor 37 installed outside the inlet side 62 of the first duct 60 at one side of the circumferential surface of the drum 21, a rotary axis 38 extended from both ends of the driving motor 37, and a suction fan 39 coupled to one end of the rotary axis 38, disposed inside the inlet side 62 of the first duct 60, and rotated with the rotary axis 38 by the driving operation of the driving motor 37, for forcibly sending inside air of the cabinet 11 into the drum 21 through the first duct 60.

A double pulley system 41 is installed on the rotary axis 38 extended to the rear side of the driving motor 37 to cause rotation of the drum 21.

A heater 45 is disposed inside the inlet side 62 of the first duct 60 at one side of the suction fan 39 to heat air sucked to the first duct 60. That is, the suction fan 39 and the heater 45 are disposed at one side of the circumferential surface of the drum 21, not both sides of the drum 21.

Here, the second duct 61 provides an exhaust passage for exhausting the air sucked into the drum 21 through the first duct 60 from the cabinet 11.

Conversely, the second duct 61 can compose the air suction passage, and the first duct 60 can compose the exhaust passage for exhausting inside air of the drum 21 from the cabinet 11.

The operation of the clothes dryer in accordance with the second embodiment of the present invention will now be explained.

When power is applied to the driving motor 37, the rotary axis 38 of the driving motor 37 is rotated. Here, the suction fan 39 and the drum 21 are rotated, respectively. As the suction fan 39 is rotated, air is sucked into the first duct 60. The sucked air is heated by the heater 39, flows in the circumferential direction of the drum 21 through the first duct 60, and is supplied into the drum 21 through the first plurality of vent holes 23. The air contacting the clothes and taking moisture in the drum 21 is exhausted from the drum 21 through the second plurality of vent holes 25, and then exhausted from the cabinet 11 through the second duct 61. On the other hand, the cap members 63 block the first plurality of vent holes 23 and the second plurality of vent holes 25 which are not covered with the first duct 60 and the second duct 61 in the circumferential direction of the drum 21, to prevent air leakage.

A clothes dryer in accordance with a third embodiment of the present invention will now be described in detail.

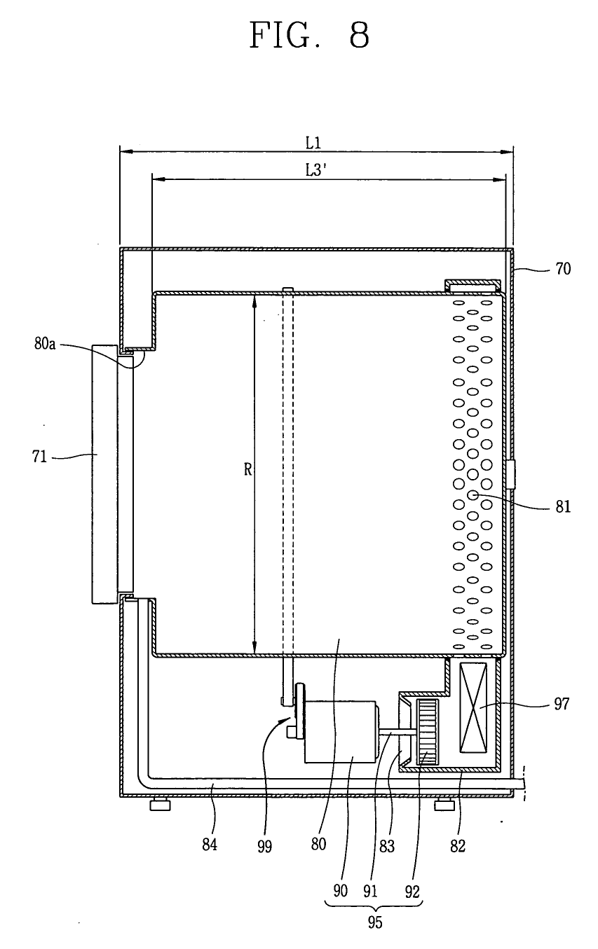

FIG. 8 is a cross-sectional diagram illustrating the clothes dryer in accordance with the third embodiment of the present invention.

As depicted in FIG. 8, in accordance with the third embodiment of the present invention, the clothes dryer includes a drum 80 rotatably installed in a cabinet 70, a plurality of vent holes 81 being formed on the circumferential surface of the drum 80, first and second ducts 82 and 84 coupled to the drum 80, respectively, for sucking and exhausting air to/from the drum 80, and a fan motor 95 for forcibly sending air through the first and second ducts 82 and 84. Here, at least one of the first and second ducts 82 and 84 is linked to the plurality of vent holes 81.

The structure of the clothes dryer in accordance with the third embodiment of the present invention will now be explained in more detail.

The cabinet 70 is formed in a rectangular-parallelepiped shape. An opening is formed on the front surface of the cabinet 70 so that the user can put clothes in the cabinet 70 or take out the clothes. The opening is opened/closed by a door 71 installed outside the cabinet 70.

The drum 80 is formed in a cylindrical shape having its front surface opened. The drum 80 is rotatably installed on the cabinet 70 so that its opened front surface can match with the opening of the cabinet 70. A length L3 of the drum 80 is almost identical to a length L1 of the cabinet 70.

The plurality of vent holes 81 are arranged at one side of the circumferential surface of the drum 80 in the rotary direction of the drum 80 vertically to a rotary center axis of the drum 80. Preferably, the plurality of vent holes 81 are formed at one side end of the circumferential surface of the drum 80 to facilitate air flow.

The first duct 82 is formed in a hoop shape on the circumferential surface of the drum 80 in order to cover the plurality of vent holes 81 to provide a passage for sucking air into the drum 80. The second duct 84 is linked to one side of the drum 80. That is, the second duct 84 is linked to the drum 80 at one side of an inlet side 80a of the drum 80 to provide a passage for exhausting inside air of the drum 80 from the cabinet 70.

Although not illustrated, as identical to the first embodiment (refer to FIG. 4) of the present invention, in the contact portions of the first duct 82 and the circumferential surface of the drum 80, a housing groove is caved in the thickness direction of the ends of the sidewalls (the covering portion) of the first duct 82 and extended in the circumferential direction, and gaskets are installed on the housing groove in order to prevent air from being externally leaked from the first duct 82. In addition, elastic members for applying an elastic force to the gaskets are installed in the housing groove behind the gaskets.

The fan motor 95 is installed at an inlet side 83 of the first duct 82 to supply air into the drum 80 through the first duct 82.

That is, the fan motor 95 includes a driving motor 90 installed outside the inlet side 83 of the first duct 82 at one side of the circumferential surface of the drum 80, a rotary axis 91 extended from both ends of the driving motor 90, and a suction fan 92 coupled to one end of the rotary axis 91, disposed inside the inlet side 83 of the first duct 82, and rotated with the rotary axis 91 by the driving operation of the driving motor 90, for forcibly sending inside air of the cabinet 70 into the drum 80 through the first duct 82.

A double pulley system 99 is installed on the rotary axis 91 extended to the rear side of the driving motor 90 to cause rotation of the drum 80.

A heater 97 is disposed inside the inlet side 83 of the first duct 82 at one side of the suction fan 92 to heat air sucked to the first duct 82. That is, the suction fan 92 and the heater 97 are disposed at one side of the circumferential surface of the drum 80, not both sides of the drum 80.

The operation of the clothes dryer in accordance with the third embodiment of the present invention will now be explained.

When power is applied to the driving motor 90, the rotary axis 91 of the driving motor 90 is rotated. Here, the suction fan 92 and the drum 80 are rotated, respectively. As the suction fan 92 is rotated, air is sucked into the first duct 82. The sucked air is heated by the heater 97, flows in the circumferential direction of the drum 80 through the first duct 82, and is supplied into the drum 80 through the first plurality of vent holes 81. The air contacting the clothes and taking moisture in the drum 80 is exhausted from the cabinet 70 through the second duct 84 linked to one side of the inlet side 80a of the drum 80.

A clothes dryer in accordance with a fourth embodiment of the present invention will now be described in detail.

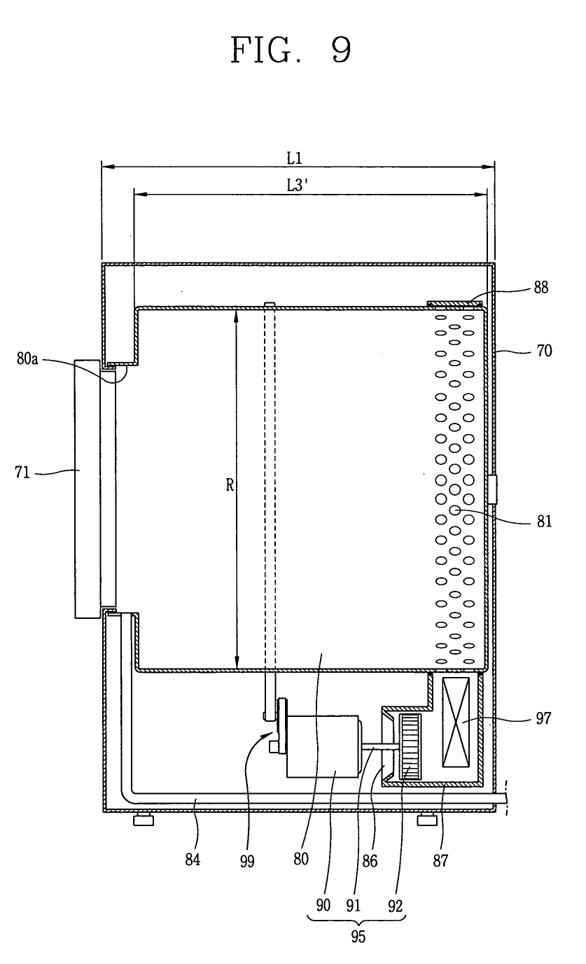

FIG. 9 is a cross-sectional diagram illustrating the clothes dryer in accordance with the fourth embodiment of the present invention.

Same drawing reference numerals are used for the same elements as those of the third embodiment of the present invention.

As illustrated in FIG. 9, in accordance with the fourth embodiment of the present invention, the clothes dryer includes a drum 80 rotatably installed in a cabinet 70, a plurality of vent holes 81 being formed on the circumferential surface of the drum 80, first and second ducts 87 and 84 coupled to the drum 80, respectively, for sucking and exhausting air to/from the drum 80, and a fan motor 95 for forcibly sending air through the first and second ducts 87 and 84. Here, at least one of the first and second ducts 87 and 84 is linked to the plurality of vent holes 81.

The structure of the clothes dryer in accordance with the fourth embodiment of the present invention will now be explained in more detail.

The cabinet 70 is formed in a rectangular-parallelepiped shape. An opening is formed on the front surface of the cabinet 70 so that the user can put clothes in the cabinet 70 or take out the clothes. The opening is opened/closed by a door 71 installed outside the cabinet 70.

The drum 80 is formed in a cylindrical shape having its front surface opened. The drum 80 is rotatably installed on the cabinet 70 so that its opened front surface can match with the opening of the cabinet 70. A length L3 of the drum 80 is almost identical to a length L1 of the cabinet 70.

The plurality of vent holes 81 are arranged at one side of the circumferential surface of the drum 80 in the rotary direction of the drum 80 vertically to a rotary center axis of the drum 80. Preferably, the plurality of vent holes 81 are formed at one side end of the circumferential surface of the drum 80 to facilitate air flow.

The first duct 87 is formed on the circumferential surface of the drum 80 in order to cover part of the plurality of vent holes 81 to provide a passage for sucking air into the drum 80. The second duct 84 is linked to one side of the drum 80. That is, the second duct 84 is linked to the drum 80 at one side of an inlet side 80a of the drum 80 to provide a passage for exhausting inside air of the drum 80 from the cabinet 70. Preferably, the first duct 87 is formed at the lower portion of the drum 80 in a channel-sectional shape, so that air passages can be formed between the first duct 87 and the circumferential surface of the drum 80.

Although not illustrated, as identical to the above-described embodiments (refer to FIG. 4) of the present invention, a housing groove is caved in the thickness direction of the ends of the sidewalls (the covering portion) of the first duct 87 and extended in the circumferential direction, and gaskets are installed on the housing groove closely to the circumferential surface of the drum 80 in order to prevent air from being externally leaked from the first duct 87. In addition, elastic members for applying an elastic force to the gaskets are installed in the housing groove behind the gaskets.

On the other hand, a cap member 88 is installed on the circumferential surface of the drum 80 to block the plurality of vent holes 81 which are not covered with the first duct 87.

Although not illustrated, the cap member 88 is formed in the same manner as that of the second embodiment (refer to FIG. 7) of the present invention. That is, the cap member 88 is formed in a hoop shape having a curvature corresponding to an outside diameter of the drum 80. A Housing groove caved in the thickness direction and extended in the circumferential direction are formed on the inside surface of the cap member 88. Gaskets are installed on the housing groove closely to the circumferential surface of the drum 80 in order to prevent inside air of the drum 80 from being externally leaked through the plurality of vent holes 81. In addition, elastic members such as sponges are installed in the housing groove behind the gaskets to apply an elastic force to the gaskets.

The fan motor 95 is installed at an inlet side 86 of the first duct 87 to supply air into the drum 80 through the first duct 87.

That is, the fan motor 95 includes a driving motor 90 installed outside the inlet side 86 of the first duct 87 at one side of the circumferential surface of the drum 80, a rotary axis 91 extended from both ends of the driving motor 90, and a suction fan 92 coupled to one end of the rotary axis 91, disposed inside the inlet side 86 of the first duct 87, and rotated with the rotary axis 91 by the driving operation of the driving motor 90, for forcibly sending inside air of the cabinet 70 into the drum 80 through the first duct 87.

A double pulley system 99 is installed on the rotary axis 91 extended to the rear side of the driving motor 90 to cause rotation of the drum 80.

A heater 97 is disposed inside the inlet side 86 of the first duct 87 at one side of the suction fan 92 to heat air sucked to the first duct 87. That is, the suction fan 92 and the heater 97 are disposed at one side of the circumferential surface of the drum 80, not both sides of the drum 80.

The operation of the clothes dryer in accordance with the fourth embodiment of the present invention will now be explained.

When power is applied to the driving motor 90, the rotary axis 91 of the driving motor 90 is rotated. Here, the suction fan 92 and the drum 80 are rotated, respectively. As the suction fan 92 is rotated, air is sucked into the first duct 87. The sucked air is heated by the heater 97, flows in the circumferential direction of the drum 80 through the first duct 87, and is supplied into the drum 80 through the plurality of vent holes 81. The air contacting the clothes and taking moisture in the drum 80 is exhausted from the cabinet 70 through the second duct 84 linked to one side of the inlet side 80a of the drum 80. On the other hand, the cap members 88 block the plurality of vent holes 81 which are not covered with the first duct 87 in the circumferential direction of the drum 21, to prevent air from being externally leaked from the drum 80.

In the above-described embodiments of the present invention, the exhaust type clothes dryer which exhausts inside air of the drum from the cabinet has been exemplified. However, it must be recognized that the present invention can be applied to a condensation type clothes dryer which exhausts inside air of a drum from the drum, removes moisture, and supplies the air into the drum.

As discussed earlier, in accordance with the present invention, the clothes dryer can increase the length of the drum almost identically to the length of the cabinet without increasing the size of the cabinet, by forming the plurality of vent holes on the circumferential surface of the drum, and forming at least one of the suction and exhaust ducts for air circulation of the drum on the circumferential surface of the drum to be linked to the vent holes. That is, the clothes dryer uses the suction/exhaust system disposed on the circumferential surface of the drum, instead of using the general suction/exhaust system having the suction fan and the heater disposed at both sides of the drum, thereby efficiently increasing the space of the drum. As a result, the clothes drying capacity also increases.

In addition, the clothes dryer can remarkably prevent creases, shrinkage and damages of the clothes and cloths.

Furthermore, air is sucked or exhausted in the circumferential direction of the drum, so that the clothes can be evenly dried.

Because the suction duct is not exposed on the rear surface of the cabinet, the suction duct is not damaged and looks better externally.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A clothes dryer, comprising:
a drum rotatably installed in a cabinet, a plurality of vent holes being formed on the circumferential surface of the drum;
first and second ducts coupled to the drum, respectively, for sucking and exhausting air to/from the drum; and
a fan motor for forcibly sending air through the first and second ducts,
wherein at least one of the first and second ducts is linked to the plurality of vent holes.

2. The clothes dryer of claim 1, wherein the plurality of vent holes are arranged in the rotary direction of the drum vertically to a rotary center axis of the drum.

3. The clothes dryer of claim 2, wherein the first duct is formed on the circumferential surface of the drum to cover the whole vent holes, for providing a passage for sucking air into the drum, and the second duct is linked to one side of the drum, for providing a passage for exhausting air from the drum.

4. The clothes dryer of claim 3, wherein a suction fan of the fan motor is installed inside an inlet side of the first duct, and a heater is installed at one side of the suction fan inside the inlet side of the first duct.

5. The clothes dryer of claim 3, wherein a housing groove is caved in the thickness direction of the covering portion of the first duct and extended in the circumferential direction, gaskets are installed on the housing groove closely to the circumferential surface of the drum in order to prevent air from being externally leaked from the first duct, and elastic members for applying an elastic force to the gaskets are installed in the housing groove behind the gaskets.

6. The clothes dryer of claim 2, wherein the first duct is formed on the circumferential surface of the drum to cover part of the plurality of vent holes, for providing a passage for sucking air into the drum, and the second duct is linked to one side of the drum, for providing a passage for exhausting air from the drum.

7. The clothes dryer of claim 6, wherein a suction fan of the fan motor is installed inside an inlet side of the first duct, and a heater is installed at one side of the suction fan inside the inlet side of the first duct.

8. The clothes dryer of claim 6, wherein a housing groove is caved in the thickness direction of the covering portion of the first duct and extended in the circumferential direction, gaskets are installed on the housing groove closely to the circumferential surface of the drum in order to prevent air from being externally leaked from the first duct, and elastic members for applying an elastic force to the gaskets are installed in the housing groove behind the gaskets.

9. The clothes dryer of claim 6, wherein a cap member is installed on the circumferential surface of the drum to block the plurality of vent holes which are not covered with the first duct.

10. The clothes dryer of claim 9, wherein the cap member is formed in a hoop shape having a curvature corresponding to an outside diameter of the drum.

11. The clothes dryer of claim 10, wherein a housing groove caved in the thickness direction and extended in the circumferential direction is formed on the inside surface of the cap member, gaskets are installed on the housing groove closely to the circumferential surface of the drum in order to prevent air from being externally leaked from the first duct, and elastic members for applying an elastic force to the gaskets are installed in the housing groove behind the gaskets.

12. The clothes dryer of claim 1, wherein the plurality of vent holes comprise:
a first plurality of vent holes arranged in the rotary direction of the drum; and
a second plurality of vent holes arranged in the rotary direction of the drum, separately from the first plurality of vent holes.

13. The clothes dryer of claim 12, wherein the first duct is formed on the circumferential surface of the drum to cover the first plurality of vent holes, and the second duct is formed on the circumferential surface of the drum to cover the second plurality of vent holes.

14. The clothes dryer of claim 13, wherein air is sucked into the drum through one of the first and second ducts, and exhausted from the drum through the other duct.

15. The clothes dryer of claim 14, wherein a suction fan of the fan motor is disposed inside an inlet side of the duct for sucking air into the drum between the first and second ducts, and a heater is disposed at one side of the suction fan.

16. The clothes dryer of claim 13, wherein housing grooves are caved in the thickness direction of the covering portions of the first and second ducts and extended in the circumferential direction, gaskets are installed on the housing grooves closely to the circumferential surface of the drum in order to prevent air from being externally leaked from the first and second ducts, and elastic members are installed in the housing grooves behind the gaskets so that the gaskets can elastically contact the circumferential surface of the drum.

17. The clothes dryer of claim 12, wherein the first duct is formed on the circumferential surface of the drum to cover part of the first plurality of vent holes, and the second duct is formed on the circumferential surface of the drum to cover part of the second plurality of vent holes.

18. The clothes dryer of claim 17, wherein air is sucked into the drum through one of the first and second ducts, and exhausted from the drum through the other duct.

19. The clothes dryer of claim 18, wherein a suction fan of the fan motor is disposed inside an inlet side of the duct for sucking air into the drum between the first and second ducts, and a heater is disposed at one side of the suction fan.

20. The clothes dryer of claim 17, wherein housing grooves are caved in the thickness direction of the covering portions of the first and second ducts and extended in the circumferential direction, gaskets are installed on the housing grooves closely to the circumferential surface of the drum in order to prevent air from being externally leaked from the first and second ducts, and elastic members are installed in the housing grooves behind the gaskets so that the gaskets can elastically contact the circumferential surface of the drum.

21. The clothes dryer of claim 17, wherein a cap member is installed on the circumferential surface of the drum to block the first plurality of vent holes which are not covered with the first duct, and a cap member is installed on the circumferential surface of the drum to block the second plurality of vent holes which are not covered with the second duct.

22. The clothes dryer of claim 21, wherein the cap members are formed in a hoop shape having a curvature corresponding to an outside diameter of the drum.

23. The clothes dryer of claim 22, wherein housing grooves caved in the thickness direction and extended in the circumferential direction are formed on the inside surface of the cap members, gaskets are installed on the housing grooves closely to the circumferential surface of the drum in order to prevent air from being externally leaked from the first and second ducts, and elastic members for applying an elastic force to the gaskets are installed in the housing grooves behind the gaskets.
